(19) United States
(12) Patent Application Publication
(10) Pub. No.: US 2026/0057284 A1
(43) Pub. Date: Feb. 26, 2026

(54) Hybrid Machine Learning for Anomaly Detection

(71) Applicant: Bank of America Corporation, Charlotte, NC (US)

(72) Inventors: Maharaj Mukherjee, Poughkeepsie, NY (US); Carl Benda, Charlotte, NC (US); Viraj Shah, Maharashtra (IN); Vijay Yarabolu, Hyderabad (IN); Aditya Krishnanand Chaubey, Maharashtra (IN); Rahul Uniyal, Uttarakhand (IN); Duy Minh Pham, Charlotte, NC (US)

(21) Appl. No.: 18/809,680

(22) Filed: Aug. 20, 2024

(51) Int. Cl. G06N 20/00

(52) U.S. Cl. CPC G06N 20/00

(57) ABSTRACT

Arrangements for providing improved anomaly detection in time series data are provided. A computing platform may receive data from one or more servers. The data may be analyzed using natural language processing to identify features in the data. A machine learning model currently deployed in a production environment may be copied and updated based on the features. The production model may be executed to generate production model outputs and the updated model may be executed to generate updated model outputs. The outputs may be compared and, if no or insufficient differences exist, the production model may be maintained in the production environment. If differences exist and are sufficient, an accuracy improvement associated with the updated machine learning model may be determined. If the accuracy improvement meets a threshold, the updated machine learning model may be deployed to the production environment. If not, the production machine learning model may be maintained.

### BACKGROUND

Aspects of the disclosure relate to electrical computers, systems, and devices for hybrid machine learning for anomaly detection.

Conventional machine learning arrangements used to identify anomalies in data have difficulty when seasonality impacts the data. For instance, changes in time series data due to day of the week, time of day, national holidays, and the like, can be identified as anomalies when, in fact, that just represent changes in the data that are not necessarily anomalous or indicative of an issue. Further, when new features become part of the data, conventional arrangements might not account for the new features and may mistakenly identify anomalies that are not anomalies. Further, conventional arrangements for anomaly detection often rely on user input to identify change points in time series data and to identify an optimum anomaly threshold. However, these manual processes can be inefficient and prone to error. Accordingly, aspects described herein provide a hybrid machine learning approach to identify anomalies in time series data by accounting for seasonality, as well as new features in the data.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with improving accuracy in detecting anomalies in time series data.

In some aspects, a computing platform may receive data from one or more servers. The data may be analyzed using, for instance, natural language processing, to identify features in the data, that may then be stored in a feature store. In some examples, a machine learning model currently deployed in a production environment may be copied and updated based on the identified features. The production model may be executed to generate production model outputs and the updated model may be executed to generate updated model outputs. The outputs may be compared and, if no differences exist, or if insufficient differences exist, the production model may be maintained in the production environment.

If differences exist and are sufficient, an accuracy improvement associated with the updated machine learning model over the production machine learning model may be determined. If the accuracy improvement meets or exceeds a threshold, the updated machine learning model may be deployed to the production environment. If not, the production machine learning model may be maintained.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing anomaly detection functions in accordance with one or more aspects described herein;

FIGS. 2A-2D depict an illustrative event sequence for anomaly detection in accordance with one or more aspects described herein;

FIG. 3 illustrates an illustrative method for anomaly detection functions according to one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, conventional anomaly detection systems often struggle to account for seasonality and new features in data. Further, many systems rely on user input to identify an optimum anomaly threshold and to identify change points in the data in which different models should be used to evaluate the data for anomalies.

Accordingly, as discussed herein, a hybrid machine learning arrangement is provided that may account for seasonality in data, as well as newly identified features. In some examples, data may be analyzed to identify features within the data. In some examples, a large language model may be used to analyze the data. The identified features may be stored in a feature store.

In some examples, a machine learning model may be generated. Generating the machine learning model may include retrieving a machine learning model currently in production and updating the model to include the identified features in the data. The updated model and the production model may be executed to generate respective outputs. The outputs may then be compared to determine whether sufficient differences exist and whether the updated model provides a sufficient improvement in accuracy. If so, the updated model may be deployed. If not, the production model may be maintained.

In some arrangements, robotic process automation may be used to identify and optimum threshold for identifying anomalies in the data. In addition, the robotic process automation may be used to plot actual vs. forecasted time series data in order to enable identification of change points in the data that may be used to retrain the machine learning model to identify change points.

### These and Various Other Arrangements Will Be Discussed More Fully Below.

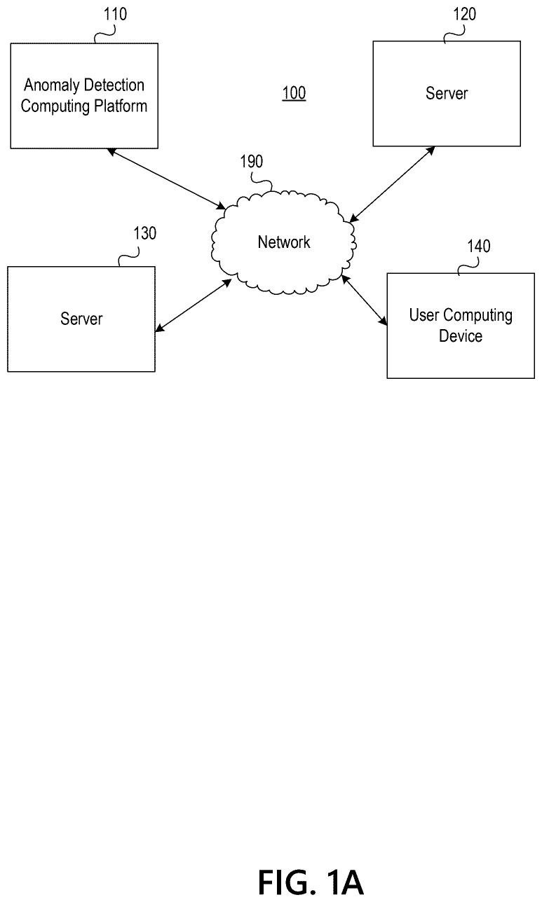

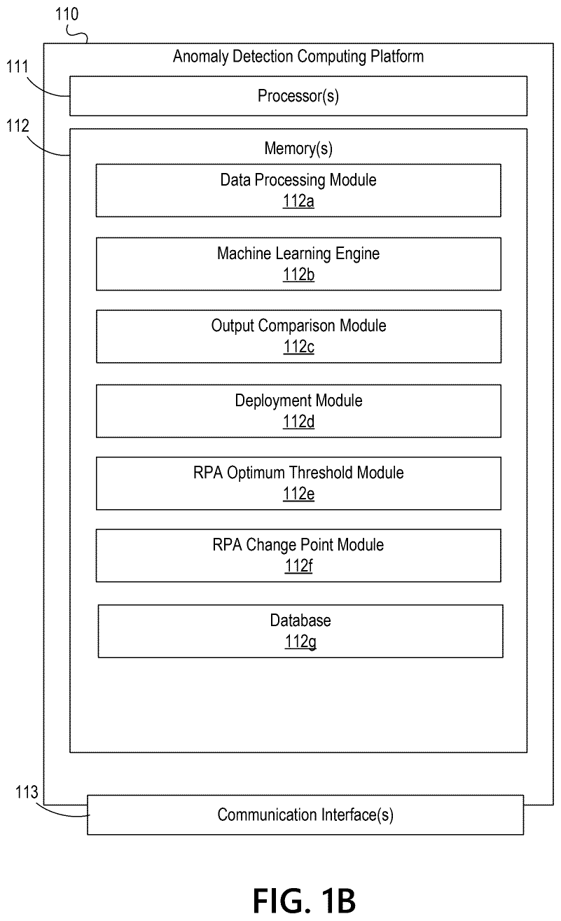

FIGS. 1A-1B depict an illustrative computing environment and devices for implementing hybrid machine learning anomaly detection functions in accordance with one or more aspects described herein. Referring to FIG. 1A, computing environment 100 may include one or more computing devices and/or other computing systems. For example, computing environment 100 may include anomaly detection computing platform 110, a first server 120, a second server 130, and user computing device 140.

Although two servers 120, 130 and one user computing device 140 are shown, any number of systems or devices may be used without departing from the invention.

Anomaly detection computing platform 110 may be configured to perform intelligent, dynamic, hybrid machine learning anomaly detection functions. For instance, anomaly detection computing platform 110 may receive data from a plurality of servers. The data may be analyzed to identify features within the data. In some examples, a natural language processing technique, such as retrieval augmented generation, may be used to analyze the data and identify the features. The identified features may be stored in a feature store.

Anomaly detection computing platform 110 may generate a machine learning model by retrieving a machine learning model currently in production and updating or training the model to include the identified features. Anomaly detection computing platform 110 may execute the updated model to output updated model outputs and may execute the production model to output production model outputs. Anomaly detection computing platform 110 may then compare the outputs to determine whether there are differences in the outputs. For instance, the outputs may be graphed to identify a Kullback-Leibler (KL) divergence within the data. If there is no divergence in the data (e.g., no differences between the outputs) the production model may be maintained. If differences are detected, anomaly detection computing platform 110 may determine whether the differences are sufficient (e.g., exceed a threshold). If not, the production model may be maintained. If so, anomaly detection computing platform 110 may determine an accuracy associated with each model. A difference in accuracy between the updated model output and the production model output may be compared to a second threshold. If the accuracy improvement associated with the updated model does not meet or exceed the threshold, the production model may be maintained. If the accuracy improvement does meet or exceed the threshold, the updated model may be deployed to a production environment, thereby replacing the former production model.

Anomaly detection computing platform 110 may further include robotic process automation (RPA) that may be used to evaluate data to identify an optimum threshold for determining or identifying an anomaly. For instance, root mean squared error (RSME) and mean absolute percentage error (MAPE) may be used to determine an optimum threshold for identifying an anomaly within the data.

In some examples, anomaly detection computing platform 110 may further execute the robotic process automation to graph actual vs. forecasted time series data to enable identification of one or more change points within the data. The identified change points may then be used to train the updated or production machine learning model in order to enable the model to more accurately identify change points in data that might require analysis using an alternate model or having different criteria or thresholds for identifying an anomaly.

Server 120 and/or server 130 may be or include one or more computer components (e.g., servers, server blades, memory, processors, or the like) and may send and receive data from a plurality of sources. In some examples, server 120 and/or server 130 may be proxy servers associated with an enterprise organization implementing the anomaly detection computing platform 110.

User computing device 140 may be or include one or more computing devices, such as a laptop computer, desktop computer, smartphone, mobile device, wearable device, or the like and may be configured to communicate with anomaly detection computing platform 110 to review or analyze data, receive and display notifications, modify one or more settings associated with anomaly detection computing platform 110, and the like.

As mentioned above, computing environment 100 also may include one or more networks, which may interconnect one or more of anomaly detection computing platform 110, first server 120, second server 130, and/or user computing device 140. For example, computing environment 100 may include network 190. Network 190 may include one or more sub-networks (e.g., Local Area Networks (LANs), Wide Area Networks (WANs), or the like). Network 190 may interconnect one or more computing devices. For example, of anomaly detection computing platform 110, first server 120, second server 130, and/or user computing device 140 may be connected via network 190.

Referring to FIG. 1B, anomaly detection computing platform 110 may include one or more processors 111, memory 112, and communication interface 113. A data bus may interconnect processor(s) 111, memory 112, and communication interface 113. Communication interface 113 may be a network interface configured to support communication between anomaly detection computing platform 110 and one or more networks (e.g., network 190, or the like). Memory 112 may include one or more program modules having instructions that when executed by processor(s) 111 cause anomaly detection computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of anomaly detection computing platform 110 and/or by different computing devices that may form and/or otherwise make up anomaly detection computing platform 110.

For example, memory 112 may have, store and/or include data processing module 112a. Data processing module 112a may store instructions and/or data that may cause or enable the anomaly detection computing platform 110 to receive data from a plurality of servers and analyze the data to identify one or more features within the data. In some examples, natural language processing techniques may be used to analyze the data. For instance, retrieval augmented generation may be used to analyze the data and identify one or more features in the data. In some examples, the identified features may be stored in a feature store in database 112g.

Anomaly detection computing platform may further have, store and/or include machine learning engine 112b. Machine learning engine 112b may store instructions and/or data that may cause or enable the anomaly detection computing platform 110 to train, execute, update and/or validate one or more machine learning models. For instance, a machine learning model may be trained to identify correlations indicating an anomaly in data based on, for instance, historical data. The machine leaning model may be deployed to a production environment and executed to identify anomalies in data. The machine learning engine 112b may further update the machine learning model based on one or more features identified by the data processing module 112a. For instance, the machine learning engine 112b may retrieve and/or copy the deployed or production machine learning model and may retrain or update the model based on the features identified by the data processing module 112a. The machine learning engine 112b may then execute both the production model to generate production model outputs and the updated model to generate updated model outputs.

Anomaly detection computing platform 110 may further have, store and/or include output comparison module 112c. Output comparison module 112c may store instructions and/or data that may cause or enable the anomaly detection computing platform 110 to compare the production model outputs to the updated module outputs to identify any differences or discrepancies in the model outputs. In some examples, the outputs may be graphed to identify a KL divergence in the data. In some examples, if a KL divergence exists, an accuracy improvement to be gained by deploying the updated machine learning model may be determined. For instance, accuracy of the production model may be compared to accuracy of the updated model to determine a delta representing an accuracy improvement.

Based on the comparison, deployment module 112d may deploy one of the models to the production environment. For instance, deployment module 112d may store instructions and/or data that may cause or enable the anomaly detection computing platform 110 to deploy or maintain in deployment the production model if no divergence exists or if a divergence exists but an accuracy improvement is below a threshold. If a divergence exists, and the accuracy improvement meets or exceeds the threshold, deployment module 112d may deploy the updated model to replace the production model in the production environment.

Anomaly detection computing platform 110 may further have, store and/or include robotic process automation optimum threshold module 112e. RPA optimum threshold module 112e may store instructions and/or data that may cause or enable the anomaly detection computing platform 110 to execute robotic process automation to determine an optimum threshold for detecting an anomaly within the data. For instance, RSME and MAPE may be used to determine the optimum threshold that may identify anomalies while not identifying false positives within the data being analyzed.

Anomaly detection computing platform 110 may further have, store and/or include RPA change point module 112f. RPA change point module 112f may store instructions and/or data that may cause or enable the anomaly detection computing platform 110 to plot actual vs. forecasted time series data to enable identification of one or more change points within the data. The identified change points may then be used, by the machine learning engine 112b, to update or retrain the machine leaning model to better or more accurately identify change points in incoming data which would otherwise be identified as anomalies.

Anomaly detection computing platform 110 may further have, store and/or include database 112g. Database 112g may store data related to identified features, determined optimum thresholds, and/or other data to perform the functions of the anomaly detection computing platform 110.

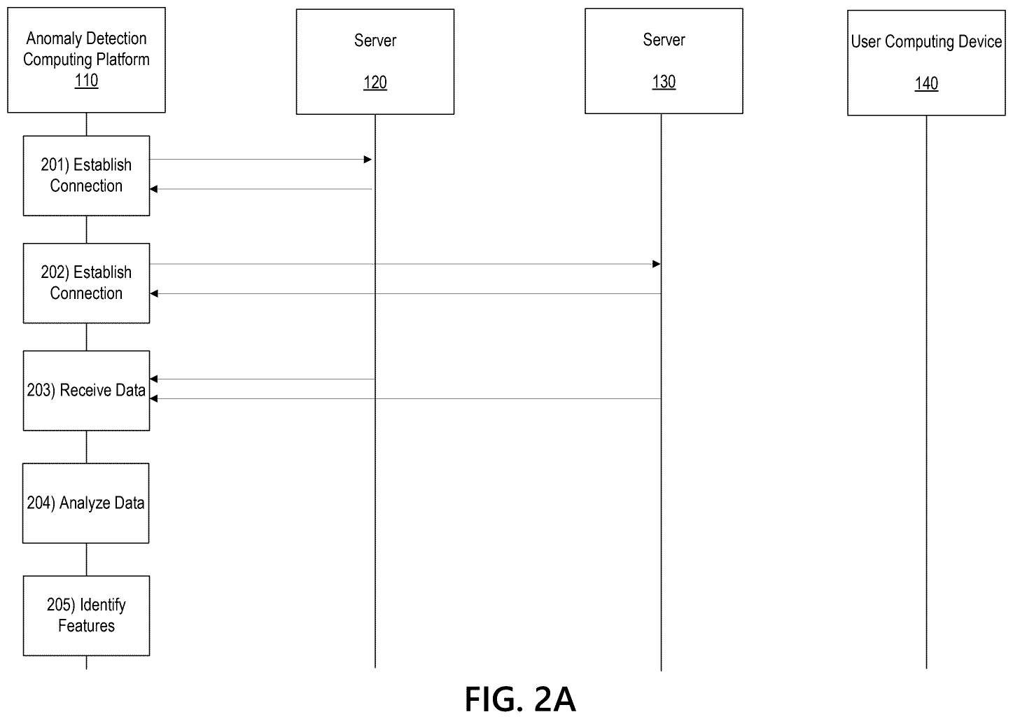

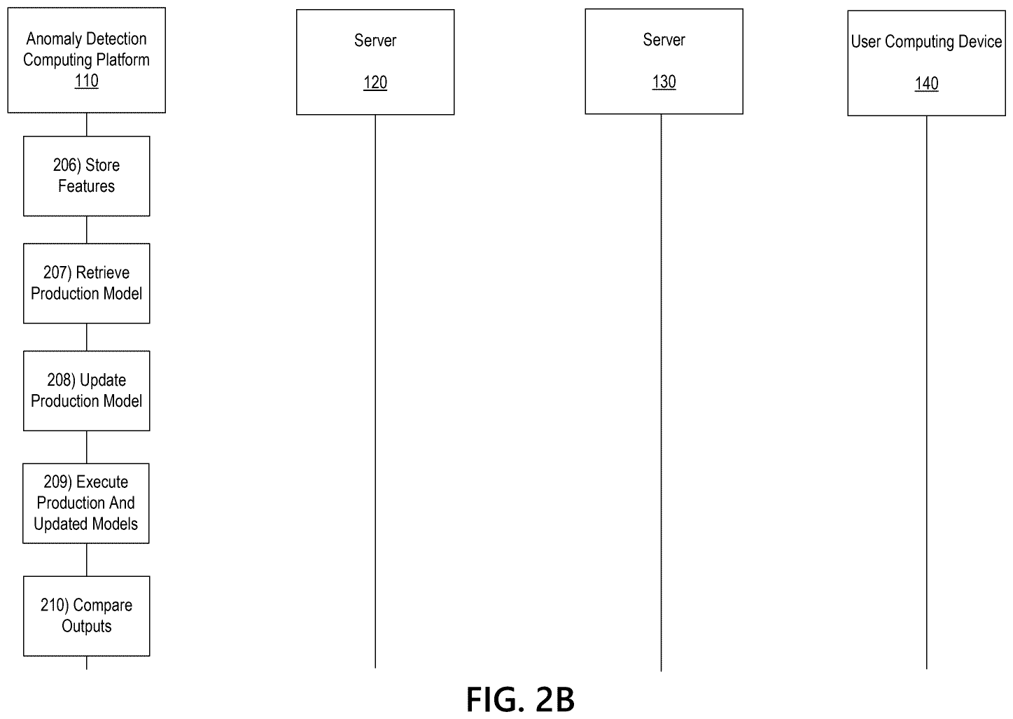

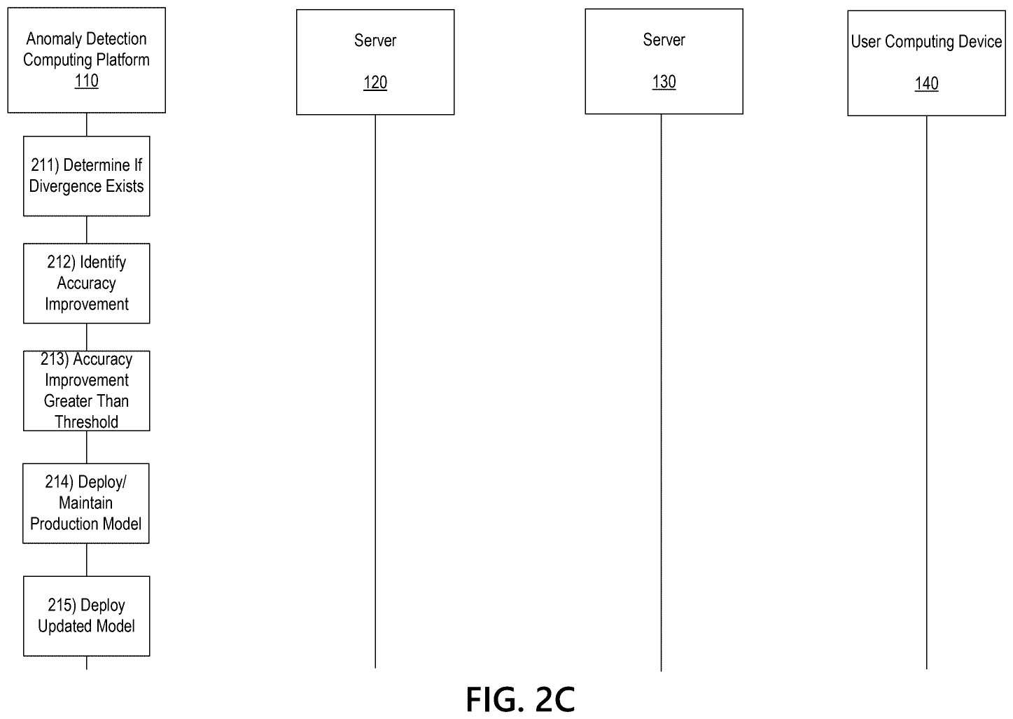

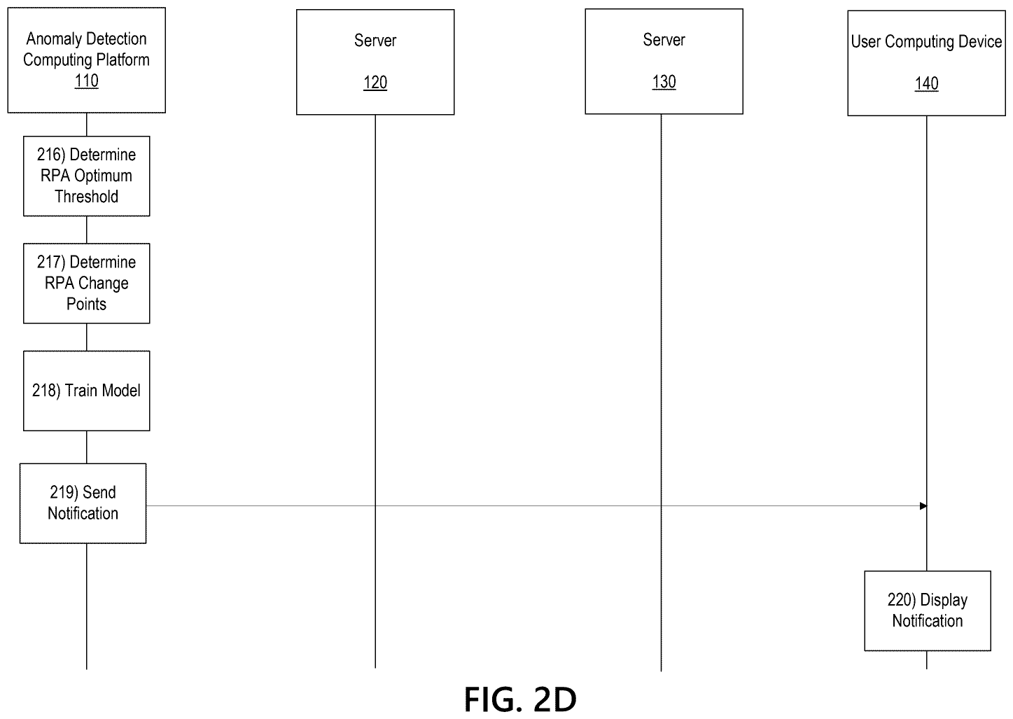

FIGS. 2A-2D depict one example illustrative event sequence for anomaly detection in accordance with one or more aspects described herein. The events shown in the illustrative event sequence are merely one example sequence and additional events may be added, or events may be omitted, without departing from the invention. Further, one or more processes discussed with respect to FIGS. 2A-2D may be performed in real-time or near real-time.

With reference to FIG. 2A, at step 201, anomaly detection computing platform 110 may establish a connection with a first server, such as server 120. For instance, anomaly detection computing platform 110 may establish a first wireless connection with server 120. Upon establishing the first wireless connection, a communication session may be initiated between anomaly detection computing platform 110 and server 120.

At step 202, anomaly detection computing platform 110 may establish a connection with a second server, such as server 130. For instance, anomaly detection computing platform 110 may establish a second wireless connection with server 130. Upon establishing the second wireless connection, a communication session may be initiated between anomaly detection computing platform 110 and server 130.

Although two servers are shown, data may be received from any number of servers without departing from the invention.

At step 203, anomaly detection computing platform 110 may receive data from the one or more servers, such as server 120 and/or server 130. The data may be continuously received (e.g., a stream of data) or received in batches.

At step 204, anomaly detection computing platform 110 may analyze the data to identify one or more features within the data. For instance, natural language processing, such as retrieval augmented generation may be used to analyze the data.

At step 205, based on the data analysis, anomaly detection computing platform 110 may identify one or more features within the data. In some examples, the features identified may be new features identified based on changes in data due to seasonality of data. In some examples, the features may be related to infrastructure, changes in a system, an incident occurring, or the like. In some arrangements, features may be identified at particular times within the data (e.g., feature a may be identified or detected at time t₁, t₂, . . . tₙ. This may be performed for one or more features detected in the data.

With reference to FIG. 2B, at step 206, anomaly detection computing platform 110 may store the identified features in a feature store in database 112g.

At step 207, anomaly detection computing platform 110 may retrieve a machine learning model currently executing in a production environment (e.g., production model). Retrieving the model may include generating a copy of the model.

At step 208, the copy of the production model may be updated or retrained to include the features identified at step 205. For instance, an updated model may be generated by updating or retraining the copy of the production model to include the identified features.

At step 209, the anomaly detection computing platform 110 may execute both the production model and the updated model to determine whether any differences exist in the outputs (e.g., whether the models diverge). For instance, each model may be executed and the outputs of the models may be compared at step 210 to determine whether differences exist in the outputs of the models. In some examples, the results may be plotted to determine whether a KL divergence, or sufficient KL divergence exists.

With reference to FIG. 2C, at step 211, the anomaly detection computing platform 110 may analyze the comparison of the output from the production model and the output from the updated model to determine whether divergence or sufficient divergence exists. If not, the process may proceed to step 214 and the production model may be deployed and/or maintained in the production environment.

If, at step 211, divergence or sufficient divergence exists between the outputs of the models, the anomaly detection computing platform 110 may identify any accuracy improvement in the updated model over the production model at step 212. For instance, an accuracy for the production model may be compared to an accuracy for the updated model to determine whether the updated model is more accurate than the production model.

In some examples, the accuracy difference (e.g., the difference between the accuracy of the updated model and the accuracy of the production model) may be compared to a threshold at step 213. If the difference does not meet or exceed the threshold (e.g., insufficient accuracy improvement), the anomaly detection computing platform 110 may proceed to step 214 and deploy the production model or maintain the production model in the production environment.

If, at step 213, the accuracy difference meets or exceeds the threshold, the anomaly detection computing platform 110 may deploy the updated model to the production environment at step 215 (e.g., replace the production model with the updated model in the production environment).

With reference to FIG. 2D, at step 216, anomaly detection computing platform 110 may execute one or more robotic process automation processes to determine an optimum threshold for detecting anomalies. For instance, anomaly detection computing platform 110 may use RSME and MAPE to determine an optimum threshold for identifying an anomaly within data being analyzed.

At step 217, anomaly detection computing platform 110 may further execute robotic process automation processes to graph actual vs. forecasted time series data to enable identification of one or more change points within the data. The identified change points may then be used to train the updated or production machine learning model in order to enable the model to more accurately identify change points in data that might require analysis using an alternate model or having different criteria or thresholds for identifying an anomaly. In some examples, the graphed actual vs. forecasted data may be transmitted to, for instance, user computing device 140, for display by the user computing device. A user may, in some examples, identify the change points and transmit the identified change points to the anomaly detection computing platform 110 to be used to further train the model to identify change points.

At step 218, anomaly detection computing platform 110 may train, retrain, update, or the like, one or more machine learning models based on the identified change points. For instance, change points identified via the RPA graphing process may be used to train one or more models to accurately detect anomalies by identifying points of change within time series data that, given a duration of the change (e.g., due to seasonality), may require different analysis, thresholds, or the like, for identifying anomalies.

At step 219, anomaly detection computing platform 110 may generate and send, to the user computing device 140, one or more notifications. For instance, anomaly detection computing platform 110 may generate and send one or more notifications indicating that a production model is being maintained, an updated model is being deployed, that an optimum threshold for anomaly detection has been determined, that one or more models have been trained based on identified change points, or the like. In some examples, sending the one or more notifications may cause the one or more notifications to be displayed by a display of the user computing device 140.

At step 220, user computing device 140 may receive and display the one or more notifications on a display of the user computing device 140.

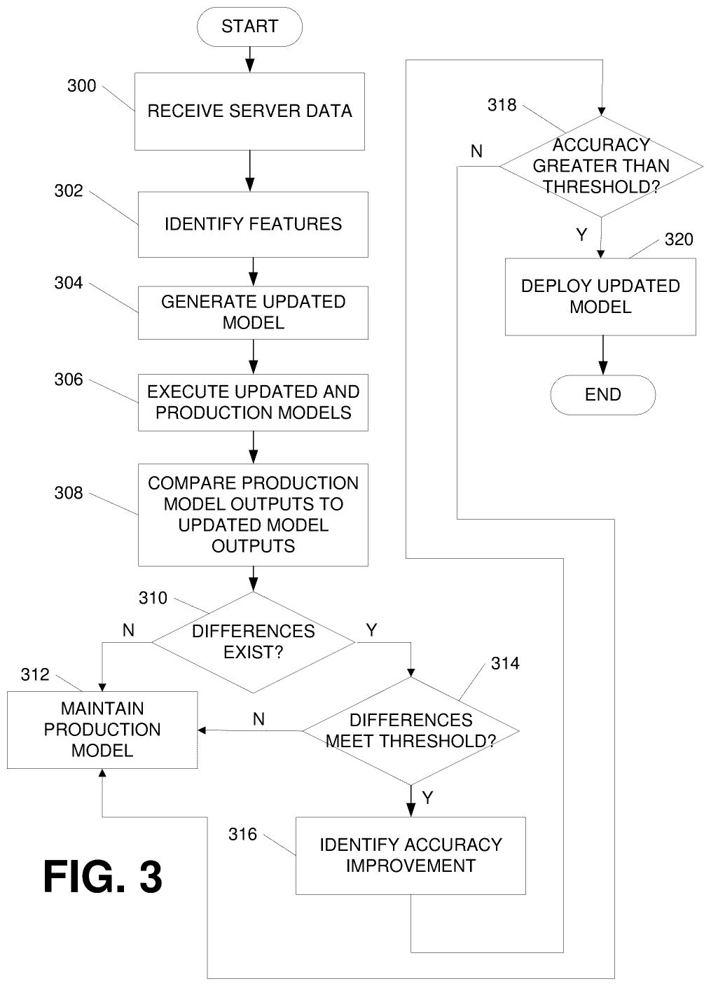

FIG. 3 is a flow chart illustrating one example method of hybrid machine learning anomaly detection in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, anomaly detection computing platform 110 may receive data from a plurality of servers. At step 302, the anomaly detection computing platform 110 may analyze the data to identify one or more features within the data. In some examples, natural language processing techniques, such as retrieval augmented generation, may be used to analyze the data. The identified features may be stored in a feature store.

At step 304, the anomaly detection computing platform may update a machine learning model to generate an updated machine learning model. In some examples, updating the machine learning model to generate the updated machine learning model may include retrieving a production machine learning model and updating or training the production machine learning model to generating the updated machine learning model to include the identified one or more features. In some arrangements, a copy of the production machine learning model may be generated and updated with the one or more features.

At step 306, the production machine learning model may be executed to generate production machine learning model outputs and the updated machine learning model may be executed to output updated machine learning model outputs.

At step 308, the outputs of the production machine learning model may be compared to the outputs of the updated machine learning model. At step 310, based on the comparing, the anomaly detection computing platform 110 may determine whether differences exist in the outputs (e.g., whether a KL divergence exists). If no differences exist, the production machine learning model may be maintained in a production environment at step 312.

If, at step 310, differences exist, at step 314, anomaly detection computing platform 110 may determine whether the differences meet or exceed a first threshold (e.g., severity, amount or the like). If not, the production model may be maintained at step 312.

If, at step 314, the differences meet or exceed the first threshold, at step 316, an accuracy improvement of the updated machine learning model over the production machine learning model may be determined based on comparing the updated machine learning model outputs to the production machine learning model outputs at step 312.

At step 318, the accuracy improvement (e.g., a difference in accuracy between the production machine learning model and the updated machine learning model) may be compared to a second threshold and, if the accuracy improvement does not meet or exceed the threshold, the production model may be maintained at step 312. If, at step 318, the accuracy improvement meets or exceeds the threshold, at step 320, the anomaly detection computing platform 110 may deploy the updated machine learning model to the production environment. In some examples, deploying the updated machine learning model may include replacing the production machine learning model with the updated machine learning model in the production environment.

In some examples, the anomaly detection computing platform 110 may use robotic process automation to determine (e.g., using RSME and MAPE), an optimum threshold for identifying an anomaly. In some arrangements, the anomaly detection computing platform 110 may further use robotic process automation to plot actual vs. forecasted time series data to identify change points in the data and train or retrain a currently deployed model using the identified change points to improve accuracy in detection change points in subsequently received server data.

Accordingly, aspects described herein provide for improved accuracy in detecting and/or predicting anomalies in time series data. Accordingly, the arrangements described herein may improve systems by reducing a number of false positives or detected anomalies that are not actual anomalies (e.g., due to seasonality or other issues). For instance, the arrangements described herein enable the system to account for changes due to seasonality, such as change in data due to time of day, day or week, time of year, occurrence of national holiday, or the like.

In conventional arrangements, a change in data due to seasonality may be viewed as an anomaly and flagged for further analysis. This arrangement is inefficient and impacts computing resources and other resources. Accordingly, the arrangements described herein provide for improved detection of changes (e.g., change points or the like) due to seasonality that may then invoke analysis with an alternate threshold for detecting an anomaly (e.g., the “seasonal” data may be evaluated with different criteria, different machine learning models, or the like to ensure the data is accurately evaluated for anomalies) and/or may account for different variables that may impact time series data.

Accordingly, as discussed herein, natural language processing, such as retrieval augmented generation, may be used to analyze server data and identify features within the data. In some examples, new features (e.g., new features not previously identified that may indicate a change due to seasonality) may be identified and, in some examples, the features may be stored in a feature store. The features may be used to generate an updated model that may be compared to a production model and may be deployed if it is sufficiently different from the production model and provides a sufficient accuracy improvement.

The arrangements described herein improve overall data and enterprise organization security by improving accuracy in detecting anomalies and avoiding false positives that may unnecessarily use computing and other resources.

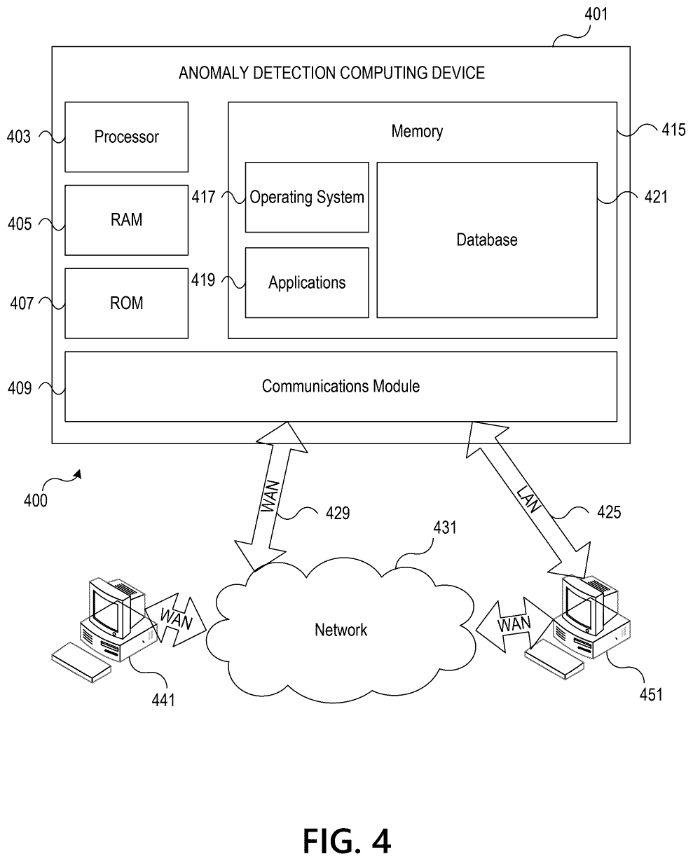

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include anomaly detection computing device 401 having processor 403 for controlling overall operation of anomaly detection computing device 401 and its associated components, including Random Access Memory (RAM) 405, Read-Only Memory (ROM) 407, communications module 409, and memory 415. Anomaly detection computing device 401 may include a variety of computer readable media. Computer readable media may be any available media that may be accessed by anomaly detection computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by anomaly detection computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on anomaly detection computing device 401. Such a processor may execute computer-executable instructions stored on a computer-readable medium.

Software may be stored within memory 415 and/or storage to provide instructions to processor 403 for enabling anomaly detection computing device 401 to perform various functions as discussed herein. For example, memory 415 may store software used by anomaly detection computing device 401, such as operating system 417, application programs 419, and associated database 421. Also, some or all of the computer executable instructions for anomaly detection computing device 401 may be embodied in hardware or firmware. Although not shown, RAM 405 may include one or more applications representing the application data stored in RAM 405 while anomaly detection computing device 401 is on and corresponding software applications (e.g., software tasks) are running on anomaly detection computing device 401.

Communications module 409 may include a microphone, keypad, touch screen, and/or stylus through which a user of anomaly detection computing device 401 may provide input, and may also include one or more of a speaker for providing audio output and a video display device for providing textual, audiovisual and/or graphical output. Computing system environment 400 may also include optical scanners (not shown).

Anomaly detection computing device 401 may operate in a networked environment supporting connections to one or more remote computing devices, such as computing devices 441 and 451. Computing devices 441 and 451 may be personal computing devices or servers that include any or all of the elements described above relative to anomaly detection computing device 401.

The network connections depicted in FIG. 4 may include Local Area Network (LAN) 425 and Wide Area Network (WAN) 429, as well as other networks. When used in a LAN networking environment, anomaly detection computing device 401 may be connected to LAN 425 through a network interface or adapter in communications module 409. When used in a WAN networking environment, anomaly detection computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive data from a plurality of servers;
analyze the data from the plurality of servers to identify one or more features;
store the one or more features in a feature store;
update a machine learning model to generate an updated machine learning model, wherein updating the machine learning model includes retrieving a production machine learning model and updating the production machine learning model to generate the updated machine learning model that includes the one or more features;
execute the updated machine learning model to output updated machine learning model outputs;
execute the production machine learning model to generate production machine learning model outputs;
compare the production machine learning model outputs to the updated machine learning model outputs;
based on the comparing, identify differences between the production machine learning model outputs and the updated machine learning model outputs;
compare the identified differences to a first threshold;
responsive to determining that the identified differences do not meet the first threshold, maintain use of the production machine learning model in a production environment;
responsive to determining that the identified differences meet or exceed the first threshold, identify an accuracy improvement based on the comparing the production machine learning model outputs to the updated machine learning model outputs;
compare the accuracy improvement to a second threshold;
responsive to determining that the accuracy improvement does not meet the second threshold, maintain use of the production machine learning model in the production environment; and
responsive to determining that the accuracy improvement does meet or exceed the second threshold, deploy the updated machine learning model to the production environment.

2. The computing platform of claim 1, wherein deploying the updated machine learning model to the production environment includes replacing the production machine learning model with the updated machine learning model.

3. The computing platform of claim 1, wherein updating the machine learning model to generate an updated machine learning model further includes generating a copy of the retrieved production machine learning model and updating the copy of the production machine learning model to generate the updated machine learning model that includes the one or more features.

4. The computing platform of claim 1, further including instructions that, when executed, cause the computing platform to:
determine, using robotic process automation, an optimum threshold for detecting an anomaly in subsequently received server data.

5. The computing platform of claim 4, wherein the optimum threshold is determined based on root mean squared error and mean absolute percentage error analysis of the data.

6. The computing platform of claim 1, further including instructions that, when executed, cause the computing platform to:
plot, using robotic process automation, actual vs. forecasted time series data;
identify change points in the data; and
train a currently deployed machine learning model based on the identified change points.

7. The computing platform of claim 6, wherein training the currently deployed machine learning model based on the identified change points causes the currently deployed machine learning model to identify change points in subsequently received server data.

8. The computing platform of claim 1, wherein analyzing the data from the plurality of servers to identify one or more features is performed using retrieval augmented generation.

9. The computing platform of claim 1, wherein identifying the differences between the production machine learning model outputs and the updated machine learning model outputs includes identifying a Kullback-Leibler divergence.

10. A method, comprising:
receiving, by a computing platform, the computing platform having at least one processor, and memory, data from a plurality of servers;
analyzing, by the at least one processor, the data from the plurality of servers to identify one or more features;
storing, by the at least one processor, the one or more features in a feature store;
updating, by the at least one processor, a machine learning model to generate an updated machine learning model, wherein updating the machine learning model includes retrieving a production machine learning model and updating the production machine learning model to generate the updated machine learning model that includes the one or more features;
executing, by the at least one processor, the updated machine learning model to output updated machine learning model outputs;
executing, by the at least one processor, the production machine learning model to generate production machine learning model outputs;
comparing, by the at least one processor, the production machine learning model outputs to the updated machine learning model outputs;
based on the comparing, identifying, by the at least one processor, differences between the production machine learning model outputs and the updated machine learning model outputs;
comparing, by the at least one processor, the identified differences to a first threshold;
responsive to determining that the identified differences do not meet the first threshold, maintaining, by the at least one processor, use of the production machine learning model in a production environment;
responsive to determining that the identified differences meet or exceed the first threshold, identifying, by the at least one processor, an accuracy improvement based on the comparing the production machine learning model outputs to the updated machine learning model outputs;
comparing, by the at least one processor, the accuracy improvement to a second threshold;
responsive to determining that the accuracy improvement does not meet the second threshold, maintaining, by the at least one processor, use of the production machine learning model in the production environment; and
responsive to determining that the accuracy improvement does meet or exceed the second threshold, deploying, by the at least one processor, the updated machine learning model to the production environment.

11. The method of claim 10, wherein deploying the updated machine learning model to the production environment includes replacing the production machine learning model with the updated machine learning model.

12. The method of claim 10, wherein updating the machine learning model to generate an updated machine learning model further includes generating a copy of the retrieved production machine learning model and updating the copy of the production machine learning model to generate the updated machine learning model that includes the one or more features.

13. The method of claim 10, further including:
determining, by the at least one processor and using robotic process automation, an optimum threshold for detecting an anomaly in subsequently received server data.

14. The method of claim 13, wherein the optimum threshold is determined based on root mean squared error and mean absolute percentage error analysis of the data.

15. The method of claim 10, further including:
plotting, by the at least one processor and using robotic process automation, actual vs. forecasted time series data;
identifying, by the at least one processor, change points in the data; and
training, by the at least one processor, a currently deployed machine learning model based on the identified change points.

16. The method of claim 15, wherein training the currently deployed machine learning model based on the identified change points causes the currently deployed machine learning model to identify change points in subsequently received server data.

17. The method of claim 10, wherein analyzing the data from the plurality of servers to identify one or more features is performed using retrieval augmented generation.

18. The method of claim 10, wherein identifying the differences between the production machine learning model outputs and the updated machine learning model outputs includes identifying a Kullback-Leibler divergence.

19. One or more non-transitory computer-readable media storing instructions that, when executed by a computing platform comprising at least one processor, memory, and a communication interface, cause the computing platform to:
receive data from a plurality of servers;
analyze the data from the plurality of servers to identify one or more features;
store the one or more features in a feature store;
update a machine learning model to generate an updated machine learning model, wherein updating the machine learning model includes retrieving a production machine learning model and updating the production machine learning model to generate the updated machine learning model that includes the one or more features;
execute the updated machine learning model to output updated machine learning model outputs;
execute the production machine learning model to generate production machine learning model outputs;
compare the production machine learning model outputs to the updated machine learning model outputs;
based on the comparing, identify differences between the production machine learning model outputs and the updated machine learning model outputs;
compare the identified differences to a first threshold;
responsive to determining that the identified differences do not meet the first threshold, maintain use of the production machine learning model in a production environment;
responsive to determining that the identified differences meet or exceed the first threshold, identify an accuracy improvement based on the comparing the production machine learning model outputs to the updated machine learning model outputs;
compare the accuracy improvement to a second threshold;
responsive to determining that the accuracy improvement does not meet the second threshold, maintain use of the production machine learning model in the production environment; and
responsive to determining that the accuracy improvement does meet or exceed the second threshold, deploy the updated machine learning model to the production environment.

20. The one or more non-transitory computer-readable media of claim 19, further including instructions that, when executed, cause the computing platform to:
determine, using robotic process automation, an optimum threshold for detecting an anomaly in subsequently received server data.
